(19) United States
(12) Patent Application Publication
(10) Pub. No.: US 2015/0062143 A1
(43) Pub. Date: Mar. 5, 2015

(54) METHOD AND APPARATUS OF TRANSFORMING IMAGES

(71) Applicant: Samsung Electronics Co., Ltd., Gyeonggi-do (KR)

(72) Inventors: Yoonkyu Jang, Gyeonggi-do (KR); Dongwook Kang, Seoul (KR); Hansub Jung, Gyeonggi-do (KR); Juyeong Lee, Seoul (KR); Myunggon Hong, Gyeonggi-do (KR)

(73) Assignee: Samsung Electronics Co., Ltd., Gyeonggi-do (KR)

(21) Appl. No.: 14/269,580

(22) Filed: May 5, 2014

(30) Foreign Application Priority Data
Sep. 3, 2013 (KR) 10-2013-0105504

(51) Int. Cl. G06T 1/00; G09G 5/00; G06F 1/32; G09G 5/37

(52) U.S. Cl. CPC G06T 1/00; G09G 5/37; G09G 5/003; G06F 1/3265
USPC 345/589; 345/619

(57) ABSTRACT

A method and an apparatus of processing an image are provided. The method of processing an image using an electronic apparatus includes obtaining at least one image; determining at least one piece of information from among property information of the at least one image, status information of the electronic apparatus, environment information related to the electronic apparatus, or user information; and determining whether the at least one image is to be transformed based on the at least one piece of information.

### PRIORITY

This application claims priority under 35 U.S.C. §119(a) to a Korean Patent Application Serial No. 10-2013-0105504 filed in the Korean Intellectual Property Office on Sep. 3, 2013, the entire disclosure of which is incorporated herein by reference.

### BACKGROUND OF THE INVENTION

1. Field of the Invention

The present invention relates generally to an electronic apparatus, and more particularly, to a method and an apparatus for transforming images.

2. Description of the Prior Art

Image processing refers to all processes of information which involve the input and output of an image. For example, image processing includes processes of pictures or movies. In image processing, for example, an image may be regarded as a two-dimensional signal to which a standard signal processing technique is applied. Through the middle of the 20th century, image processing had been conducted by means of an analog technique, using a method related to optics. This technique of image processing is still used in holography, but recently, due to the enhanced speed of processing of computers and electronic apparatuses, it has been mostly substituted by a digital image processing technique. Digital image processing has an easier implementation process and is more precise than analog processing. In order to achieve faster image processing, a computing technology such as pipeline processing may be used.

According to the prior art, when an image is processed (i.e., transformed) using an electronic apparatus, the image is uniformly transformed without reflecting various information (e.g., illuminance information around the electronic apparatus) related to the electronic apparatus, causing the visibility of the image to be degraded. In addition, since the image is processed without considering property information (e.g., information on still images or moving images) of the image, the power consumption increases due to unconditional processing (e.g., transformation) of the image. Further, according to the prior art, a large amount of data is processed, which incurs a burden on a Central Processing Unit (CPU) or a Graphics Processing Unit (GPU).

### SUMMARY

The present invention has been made to address at least the problems and disadvantages described above, and to provide at least the advantages described below.

Accordingly, an aspect of the present invention provides a method and an apparatus of transforming an image by which the image is processed (i.e., transformed) with, for example, enhancement of the image visibility, a reduction of power consumption, and a reduction in the burden on a CPU/GPU.

Another aspect of the present invention provides an apparatus and a method of processing an image. The image may be selectively processed based on the various information so that power consumption can be reduced. Further, the image may be processed by reflecting various information related to the electronic apparatus, so that an enhanced image can be provided to the user.

In accordance with an aspect of the present invention, a method of processing an image using an electronic apparatus is provided. The method includes obtaining at least one image; determining at least one piece of information from among property information of the at least one image, status information of the electronic apparatus, environment information related to the electronic apparatus, or user information; and determining whether the at least one image is to be transformed based on the at least one piece of information.

In accordance with another aspect of the present invention, an image processing apparatus is provided. The apparatus includes an obtaining module that obtains at least one image; an information module that determines at least one piece of information from among property information of the at least one image, status information of the electronic apparatus, environment information related to the electronic apparatus, or user information; and a processing module that determines whether the at least one image is to be transformed based on the at least one piece of information.

In accordance with another aspect of the present invention, a non-transitory computer-readable recording medium having recorded thereon instructions which are executed by at least one processor is provided to perform obtaining at least one image; determining at least one piece of information from among property information of the at least one image, status information of the electronic apparatus, environment information related to the electronic apparatus, or user information; and determining whether the at least one image is to be transformed based on the at least one piece of information.

### BRIEF DESCRIPTION OF THE DRAWINGS

The above and other aspects, features and advantages of the present invention will be more apparent from the following detailed description in conjunction with the accompanying drawings, in which:

FIG. 1 is a block diagram illustrating an electronic apparatus according to an embodiment of the present invention;

FIG. 2 is a block diagram illustrating hardware of the electronic apparatus according to an embodiment of the present invention;

FIG. 3 is a block diagram illustrating software of the electronic apparatus according to an embodiment of the present invention;

FIG. 4 is a block diagram illustrating an image processing apparatus according to an embodiment of the present invention;

FIG. 5 illustrates a user interface for transforming an image according to an embodiment of the present invention;

FIG. 6 is a graph illustrating a degree relation of image transformation depending on image processing information according to various embodiments of the present invention;

FIG. 7 is a flowchart illustrating a method of processing an image using an electronic apparatus according to an embodiment of the present invention; and

FIG. 8 is a flowchart illustrating a method of transforming an image using an electronic apparatus according to an embodiment of the present invention.

### DETAILED DESCRIPTION OF EMBODIMENTS OF THE PRESENT INVENTION

Hereinafter, various embodiments of the invention will be described with reference to the accompanying drawings. Here, it should be noted that the identical elements consequently bear the same reference numerals of the previous drawings. In addition, a detailed description of well-known functions and configurations will be omitted so as not to make the scope of the present invention unclear. It should be noted that the following description will focus on the substance necessary for the understanding of steps of the present invention, while minor details will be omitted so as not to make the subject matter of the present invention to be obscure.

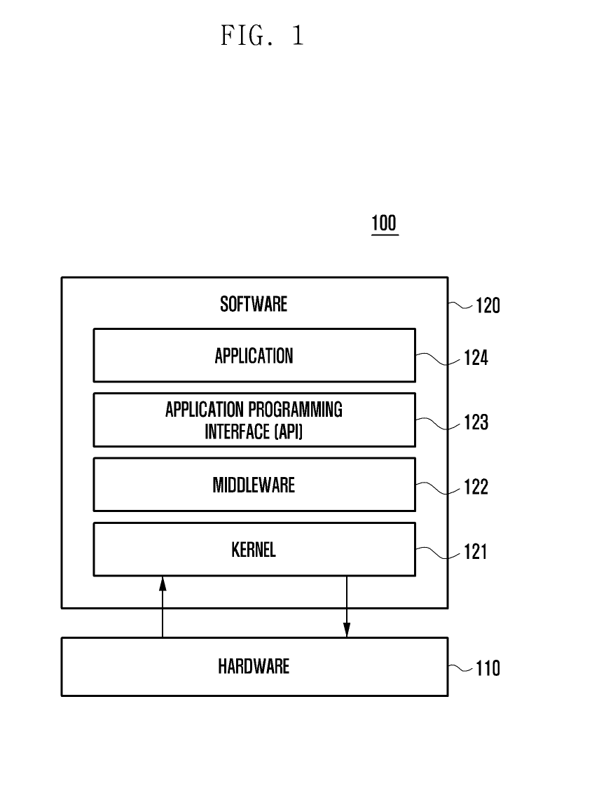

FIG. 1 is a block diagram schematically illustrating an electronic apparatus 100, according to an embodiment of the present invention.

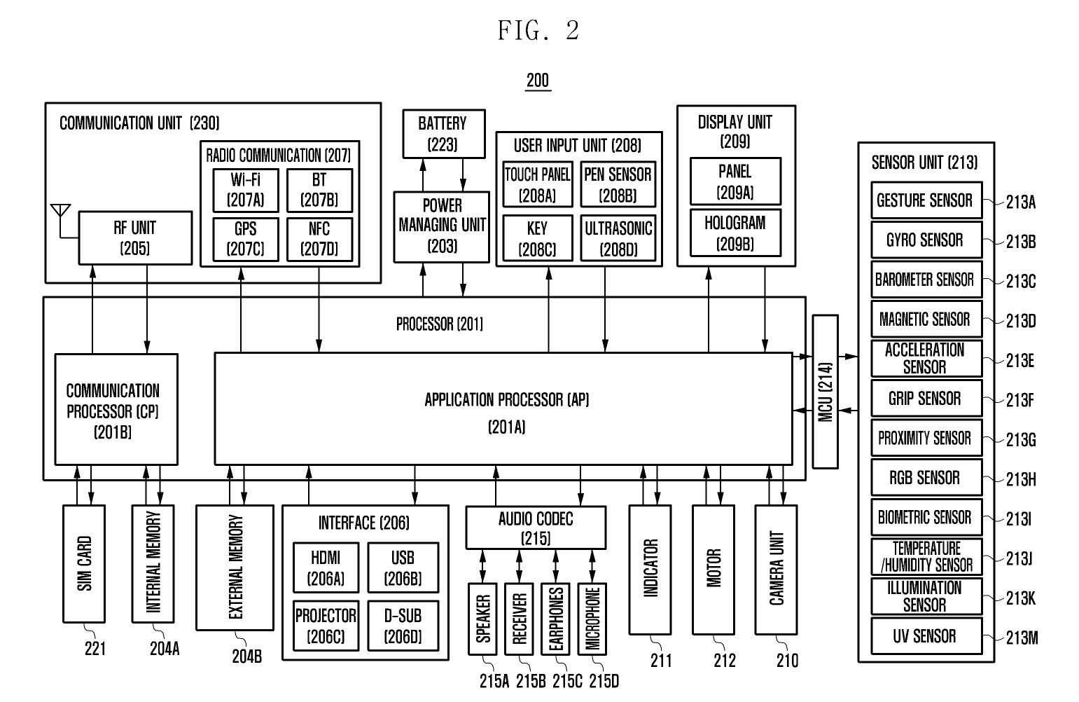

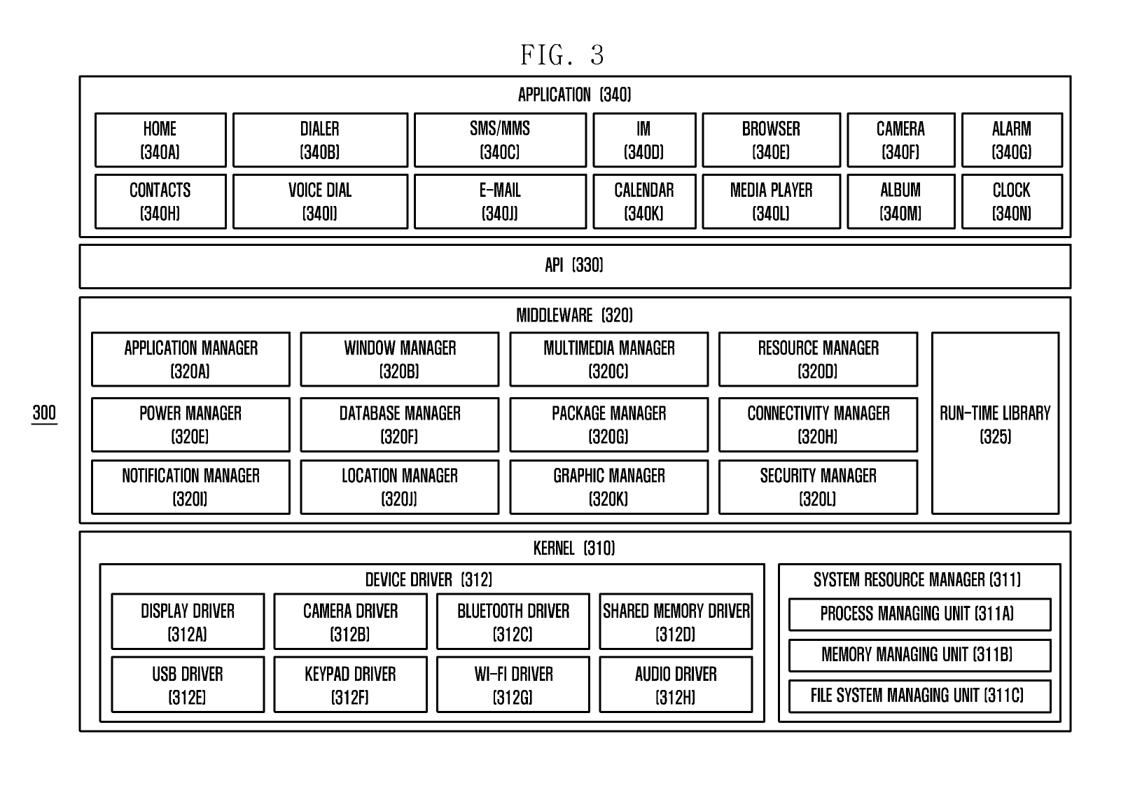

Referring to FIG. 1, an electronic apparatus 100 may include hardware 110 or software 120. The hardware 110 will be described with reference to FIG. 2. The software 120 may include a kernel 121, middleware 122, an application programming interface (API) 123 or applications 124, which will be described in detail with reference to FIG. 3.

The electronic apparatus 100 may be, for example, electronic clocks, refrigerators, air conditioners, cleaners, artificial intelligence robots, TVs, Digital Video Disk (DVD) players, audio players, ovens, microwaves, washing machines, electronic bracelets, electronic necklaces, air purifiers, electronic frames, various medical devices (e.g., a Magnetic Resonance Angiography (MRA), a Magnetic Resonance Imaging (MRI), a Computed Tomography (CT) machine, and an ultrasonic machine), navigation devices, black boxes, set-top boxes, electronic dictionaries, automotive devices, shipbuilding devices, aviation devices, security devices, electronic clothes, electronic keys, agricultural-stockbreeding-fisheries devices, desktop Personal Computers (PCs), laptop PCs, Personal Digital Assistants (PDAs), Portable Multimedia Players (PMPs), tablet PCs, mobile phones, video phones, smart phones, electronic book readers, cameras, wearable devices, wireless devices, Global Positioning System (GPS) receivers, hand-held devices, MP3 players, camcorders, game consoles, wrist watches, Head-Mounted Displays (HMDs), flat panel display devices, digital picture frames, electronic boards, electronic signature receiving devices, projectors, or the like. It would be obvious to those skilled in the art that the electronic apparatus is not limited to the above-described devices.

FIG. 2 is a block diagram illustrating hardware 200 (i.e., the hardware 110 as shown in FIG. 1) of the electronic apparatus, according to an embodiment of the present invention.

Referring to FIG. 2, the hardware 200 may include at least one processor 201. For example, as shown in FIG. 2, the processor 201 may include at least one Application Processor (AP) 201A, and at least one Communication Processor (CP) 201B. The AP 201A is a processor that operates an operating system or application programs to control elements of a plurality of hardware connected to the AP 201A or software. The AP 201A processes and calculates various data including multimedia data, which may be implemented by, for example, a System on Chip (SoC). According to the implementation, the processor 201 may further include a Graphic Processing Unit (GPU).

In addition, the CP 201B is a processor that performs a communication function of the electronic apparatus (e.g., the electronic apparatus 100 shown in FIG. 1) including the hardware 200 (e.g., the hardware 110 shown in FIG. 1), which may be implemented by, for example, the SoC. According to the implementation, the CP 201B performs at least a part of a multimedia control function. In addition, the CP 201B performs identification and authentication of a terminal in a communication network using a Subscriber Identification Module (SIM), such as a SIM card 221, and may provide services such as voice calls, video calls, text messaging, or delivery of packet data to a user. Further, the CP 201B controls transmission and reception of data of a Radio Frequency (RF) unit 205. Although in FIG. 2, elements, such as the CP 201B, a power control unit 203 or a memory 204, are provided separately from the AP 201A, the AP 201A may include at least one (e.g., the CP 201B) of the above-described elements according to another embodiment of the present invention.

The RF unit 205 performs transmission and reception of data, for example, transmission and reception of a RF signal or a calling electronic signal. Although not shown in the drawing, the RF unit 205 may include, for example, a transceiver, a Power Amp Module (PAM), a frequency filter, or a Low Noise Amplifier (LNA). In addition, the RF unit 205 may include components, for example, conductors or wires, for transmitting and receiving an electronic signal through free space in a wireless communication.

The hardware 200 may include a internal memory 204A or an external memory 204B. The internal memory 204A includes at least one of a volatile memory (e.g., a Dynamic RAM (DRAM), a Static RAM (SRAM), a Synchronous DRAM (SDRAM), etc) or non-volatile memory (e.g., an One Time Programmable ROM (OTPROM), a Programmable ROM (PROM), an Erasable and Programmable ROM (EPROM), an Electrically Erasable and Programmable ROM (EEPROM), a mask ROM, a flash ROM, etc). According to an embodiment of the present invention, the AP 201A or the CP 201B load instructions or data received from at least one of non-volatile memories or other elements, which are connected to the AP 201A or the CP 201B, to volatile memories to be thereby processed. In addition, the AP 201A or the CP 201B preserve the data received from the other elements or generated data in the non-volatile memory.

The external memory 204B may further include, for example, a Compact Flash (CF), a secure digital (SD), a Micro-SD, a Mini-SD, an extreme Digital (xD), or a memory stick.

The power managing unit 203 controls the power of the hardware 200. Although not shown in the drawing, the power control unit 203 may include, for example, a Power Management Integrated Circuit (PMIC), a charger Integrated Circuit (IC), or a battery gauge. The PMIC may be mounted, for example, in integrated circuits or SoC semiconductors. The type of charging is wired charging or wireless charging. The charger IC allows a battery to be charged and prevents an inflow of an over-voltage or an over-current from a charger. At this time, the charger IC is provided in the form of at least one of the wired charging or the wireless charging. The wireless charging may include, for example, magnetic resonance means, magnetic induction means, or electromagnetic wave means, and additional circuits, for example, a coil loop, a resonance circuit and a rectifier, for the wireless charging may be added. The battery gauge measures at least one of a percentage of a battery 223, a voltage, a current or a temperature of the charging. The battery 223 generates and supplies power, and may be, for example, a rechargeable battery.

An interface 206 includes at least one of, for example, a HDMI (mHL) 206A, a Universal Serial Bus (USB) 206B, a projector 206C, a D-subminiature 206D, a Secure Digital (SD)/Multi-Media Card (MMC) (not shown), or an Infrared Data Association (IrDA) (not shown).

A communication unit 230 provides a wireless communication function using a wireless frequency, and includes at least one of the RF unit 205 and a radio communication unit 207. The radio communication unit 207 includes at least one of a Wi-Fi 207A, a Bluetooth (BT) 207B, a GPS 207C, or a Near Field Communication (NFC) 207D. Additionally or selectively, the communication unit 230 may include a network interface (e.g., a Local Area Network (LAN), card) or a modem for connecting the hardware 200 with a network (e.g., the Internet, a LAN, a Wide Area Network (WAN), a telecommunication network, a cellular network, a satellite network, or a Plain Old Telephone Service (POTS), or the like).

A user input unit 208 receives an input of various instructions from a user. The user input unit 208 includes at least one of, for example, a touch screen panel 208A, a digital pen sensor 208B, keys 208C, or an ultrasonic input device 208D. The touch screen panel 208A may recognize a touch input by means of at least one of, for example, a capacitance type, a pressure type, an infrared type, or an ultrasonic type. In addition, the touch screen panel 208A may further include a controller. In the case of the capacitance type, recognition can be made for a proximity as well as a direct touch. The touch screen panel 208A may further include a tactile layer. In this case, the touch screen panel 208A provides a user with a tactile reaction. The digital pen sensor 208B may be implemented, for example, by the same method as the touch input from a user, or using a separate recognition sheet. The keys 208C may employ, for example, a keypad or touch keys. The ultrasonic input device 208D detects a sound wave by a microphone (e.g., a microphone 215D) at a terminal with a pen that generates an ultrasonic signal to thereby recognize data over the wireless network. According to an embodiment of the present invention, for example, by means of the communication unit 230, the hardware 200 may receive a user input from external devices (e.g., a network, computers, or servers) which are connected with the communication unit 230.

A display unit 209 is a device for displaying pictures or data to a user, which may be, for example, a panel 209A or a hologram 209B. The panel 209A may employ, for example, a Liquid Crystal Display (LCD) or an Active Matrix Organic Light Emitting Diode (AMOLED). A controller for controlling the panel 209A may be further provided. The panel 209A may be implemented to be, for example, flexible, transparent, or wearable. The panel 209A is configured to be a single module with the touch screen panel. The hologram 209B displays three-dimensional images in the air using scattering of light.

A camera unit 210 takes pictures and movies, and includes at least one image sensor (e.g., front lenses or rear lenses), an Image Signal Processor (ISP) (not shown), or a flash LED (not shown) according to an embodiment of the present invention.

An indicator 211 displays certain states, for example, a booting state, a messaging state, or a charging state, of the hardware 200 or a part (e.g., the AP 201A) thereof. A motor 212 transforms an electric signal to a mechanical oscillation.

A sensor unit 213 may include, for example, a gesture sensor 213A, a gyro-sensor 213B, a barometer sensor 213C, a magnetic sensor 213D, an acceleration sensor 213E, a grip sensor 213F, a proximity sensor 213G, a Red-Green-Blue (RGB) sensor 213H, a biometric sensor 213I, a temperature/humidity sensor 213J, an illuminance sensor 213K, an ultraviolet (UV) sensor 213L, an E-nose sensor, an electromyography (EMG), an EEG sensor, an electrocardiogram (ECG) sensor, a fingerprint sensor, or the like. According to an embodiment of the present invention, the hardware 200 may further include a Micro Controller Unit (MCU) 214 for controlling the sensor unit 213.

An audio codec 215 transforms a voice into an electric signal, and vice versa. The audio codec 215 transforms voice information that is input or output by, for example, a speaker 215A, a receiver 215B, an earphone 215C, or a microphone 215D. Although not shown in the drawing, the hardware 200 may include a processor (e.g., a GPU) to support a mobile TV. The processor for supporting the mobile TV processes data according to standards of, for example, a Digital Multimedia Broadcasting (DMB), a Digital Video Broadcasting (DVB), or a media flow.

The above-described names of the elements of the hardware, according to an embodiment of the present invention, may vary with the types of electronic apparatus. The hardware, according to an embodiment of the present invention, may be configured to include at least one of the above-described elements, and some elements may be omitted, or other elements may be further included.

FIG. 3 is a block diagram schematically illustrating software 300 (i.e., the software 120, as shown in FIG. 1) of the electronic device, according to an embodiment of the present invention. The software 300 may be implemented in hardware 200 and include an Operating System (OS) that controls resources related to the electronic apparatus 100, or various applications 340 which are executed under the OS. The OS may be, for example, Android, iOS, Windows, Symbian, Tizen, Bada, or the like.

A kernel 310 may include a system resource manger 311 or a device driver 312. For example, the system resource manager 311 may include a process managing unit 311A, a memory managing unit 311B, or a file system managing unit 311C, and performs a control, allocation or collection of system resources.

The device driver 312 accesses and controls various elements of hardware 200 in the electronic apparatus 100. In order to do so, the device driver 312 may be divided into interfaces and each driver module may be provided by hardware suppliers. For example, the device driver 312 may include at least one of a display driver 312A, a camera driver 312B, a Bluetooth driver 312C, a shared memory driver 312D, a USB driver 312E, a keypad driver 312F, a Wi-Fi driver 312G, an audio driver 312H, or inter-process communication (IPC) driver (not shown).

A middleware 320 is configured to include a plurality of modules which are pre-composed to provide common functions necessary for various applications. The middleware 320 provides common necessary functions through the API 330 in order to effectively use limited system resources inside the electronic apparatus for the applications 340. The middle ware 320 includes at least one of, for example, a plurality of modules such as an application manager 320A, a window manager 320B, a multimedia manager 320C, a resource manager 320D, a power manager 320E, a database manager 320F, a package manager 320G, or the like.

The application manager 320A manages a life cycle of at least one of the applications 340. The window manager 320B manages a GUI resource used in a screen. The multimedia manager 320C recognizes a format necessary for reproduction of various media files, and performs encoding or decoding of the media files using a codec corresponding to the format. The resource manager 320D manages resources such as a source code of at least one of the application's 340 memories or storages. The power manager 320E manages a battery or a power source in cooperation with a basic input/output system (BIOS), and provides power information required for the step. The database manager 320F manages generating, searching or changing of a database used in at least one of the applications 340. The package manager 320G manages an installation or an update of the application distributed in the form of a package file.

According to an embodiment of the present invention, the middleware 320 includes at least one of a connectivity manager 320H, a notification manager 320I, a location manager 320J, a graphic manager 320K, or a security manager 320L.

The connectivity manager 320H manages a wireless connection of, for example, Wi-Fi or Bluetooth. The notification manager 320I displays or notifies a user of events such as received massages, appointments, proximity notifications in a manner that does not disturb the user. The location manager 320J manages location information of an electronic apparatus. The graphic manager 320K manages a graphic effect to be provided to a user and interfaces related thereto. The security manager 320L provides general security functions required for system security or a user authentication.

In the case of an electronic apparatus 100 utilizing a phone call function, the middleware 320 may further include a telephone manager (not shown) to manage a voice or video phone call function of the electronic apparatus.

According to an embodiment of the present invention, the middleware 320 includes a run-time library 325 or other library modules (not shown). The run-time library 325 is a library module that a compiler uses to add new functions through a programming language during execution of applications. For example, the rum-time library 325 performs functions of input/output, management of memories, or calculation of formulas. The middleware 320 may be combined with various functions of the above-described internal element modules to a new middleware to be used. The middleware 320 may provide modules which are specialized according to the types of operating systems in order to provide differentiated functions.

In addition, the middleware 320 may dynamically remove some of the typical elements or add new elements. Accordingly, some of the elements described in the embodiment of the present invention may be omitted, or other elements may be further provided. Alternatively, the elements previously described may be replaced with elements of different names but having similar functions.

The API 330, that is a group of API programming functions, may be provided with a different configuration according to operating systems. For example, in the case of Android or iOS, for example, a single API set may be provided to each of the flatforms. In the case of Tizen, for example, two or more API sets may be provided.

The applications 340 denote at least one application program that is executed in the electronic apparatus 100 using the API 330. The applications 340 may include, for example, a preloaded application or a third party application. The applications 340 may include at least one of a home 340A for returning to a home image, a dialer 340B, a Short Message Server (SMS)/Multi-media Message Service (MMS) 340C, an Instant Message (IM) 340D, a browser 340E, a camera 340F, an alarm 340G contact list (or an address book) 340H, a voice dial 340I, an e-mail 340J, a calendar 340K, a media player 340L, an album 340M, or a clock 340N.

The names of the above-described elements of the software, according to an embodiment of the present invention, may vary with the type of the operating system. Also, the software, according to an embodiment of the present invention, may include at least one of the above-described elements, lack some of the elements, or further include other elements.

Hereinafter, an image processing apparatus according to an embodiment of the present invention will be described with reference to the related drawings.

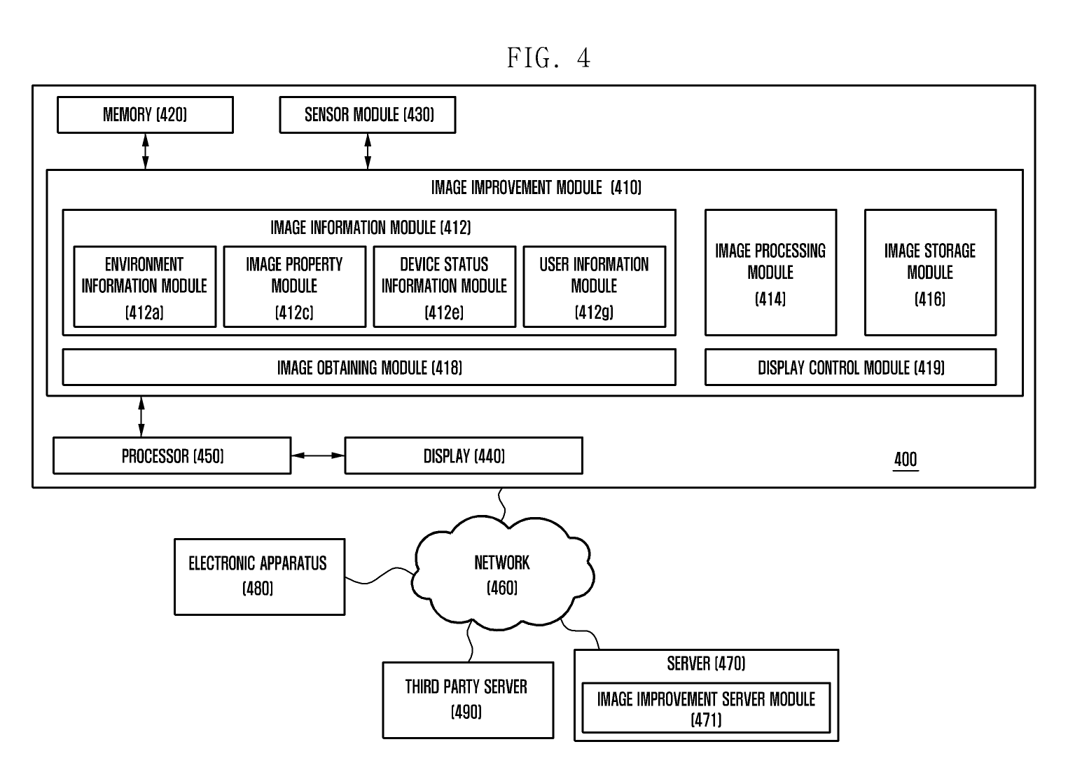

FIG. 4 is a block diagram illustrating an image processing apparatus 400 (e.g., an electronic apparatus including the hardware 200 shown in FIG. 2), according to an embodiment of the present invention. For example, according to an embodiment of the present invention, the image processing apparatus 400 includes an image improvement module 410, a memory 420, a sensor module 430, a display 440, and a processor 450.

The image improvement module 410 performs various processes such as determining whether a given (i.e., an original) image is to be transformed based on at least one piece of information, and transforming or storing of the image according to the result. For example, as shown in FIG. 4, the image improvement module 410 may include an image information module 412, an image processing module 414, an image storage module 416, an image obtaining module 418, and a display control module 419.

The image information module 412 determines (i.e., recognizes) image processing information that is used in the processing (i.e., transforming) of the image. According to an embodiment of the present invention, as shown in FIG. 4, the image information module 412 includes an environment information module 412a, an image property information module 412c, a device status information module 412e, and a user information module 412g.

The environment information module 412a determines environment information related to the image processing apparatus 400. For example, the environment information module 412a may analyze the environment information received from the sensor module 430 (i.e., the sensor unit 213, as shown in FIG. 2). For example, the sensor module 430 may include various sensors such as an illuminance sensor, an ultraviolet (UV) sensor, or an infrared sensor. The environment information module 412a determines the environment information, such as the illuminance, the intensity of an ultraviolet ray, or the intensity of an infrared ray by means of the illuminance sensor, the UV sensor, or the infrared sensor.

The image property information module 412c analyzes and determines property information of the given image. For example, the image property information module 412c may determine whether the image to be processed is a moving image, a still image, an image related to games, or an screen image being scrolled. According to an embodiment of the present invention, the image includes a web page displayed by a web browser, or a page provided by a native program such as a phone call program or a word program. Additionally or alternatively, the image may be a whole image or a partial image which is displayed on the display 440 (i.e., the display unit 209, shown in FIG. 2).

The device status information module 412e determines status information of the image processing apparatus 400. For example, according to an embodiment of the present invention, the device status information module 412e may determine brightness information of a display 440, or information on the degree of image transformation that is set up by a user. The degree of image transformation may include, for example, information about the extent to which the given image is to be transformed in order to improve the visibility of an image to be output to the user.

The device status information module 412e determines a standstill state or a moving state (e.g., shaking) of the image processing apparatus 400. According to an embodiment of the present invention, the sensor module 430 includes a gyro-sensor, and the information about a standstill state or a moving state of the image processing apparatus 400 may be decided (i.e., recognized) by means of the gyro-sensor.

The user information module 412g determines, for example, information about a user of the image processing apparatus 400. For example, the user information module 412g may determine pupil information (e.g., the size of a pupil, or the location of a pupil) of a user by means of an object sensing device such as a camera 210. In this case, the user information module 412g determines, for example, a specified area where a user is gazing on the display 440 using the pupil information (e.g., the size of a pupil, or the location of a pupil) of the user.

In addition, for example, after detecting the pattern of change in the location of body parts (e.g., a face or a pupil) of a user, a standstill state or a moving state of the user may be determined based on the result. For example, the degree of a movement of a certain body part (e.g., a face or a pupil) of the user may be detected to be low, medium, or high in spatial and temporal terms, according to the state in which the user of the image processing apparatus 400 is staying motionless (e.g., lying, seating or standing), walking, running, or moving actively.

The image processing module 414 determines whether the image is to be transformed based on the image processing information determined by the image information module 412. For example, the image processing module 414 determines the image transformation based on at least one of the environment information related to the image processing apparatus 400, the user information, the status information of the image processing apparatus 400, or the image property information. Further, when the image is determined to be transformed, the image processing module 414 determines the degree of transformation, to which the image is to be transformed.

For example, the image processing module 414 processes the given image differently according to whether the image is a moving image or a still image. When the image has no change, the image processing module 414 transforms the image, and when the image has a change (e.g., in a case of a moving image or an image of a screen that is being scrolled), an image corresponding to at least one of a multitude of frames constituting the moving image may be selectively transformed.

For example, if the image is a still image of one frame, the image processing module 414 transforms the image. Contrarily, if the image is input as successive images of a multitude of frames, the image processing module 414 transforms, for example, the image of the last frame only, when the image has stopped. With the above transformation of the image, a power consumption and a load of a CPU/GPU resulting from the transformation of each of frames in the moving image may be attenuated.

In addition, for example, if the image includes at least two images, the image processing module 414 transforms the images in a manner by which at least one image is transformed by a different degree. For example, when the given image includes at least a first image and a second image, the image processing module 414 applies a first degree of transformation to the first image and a second degree of transformation to the second image, respectively. This is because the image processing information corresponding to the first image might be different from that corresponding to the second image.

The image processing module 414 determines whether the image is to be transformed based on the environment information related to the image processing apparatus 400. For example, the image processing module 414 determines whether the image is to be transformed and the degree of image transformation according to at least one of the illuminance, the intensity of an ultraviolet ray or the intensity of an infrared ray. For example, if the illuminance, the intensity of an ultraviolet ray or the intensity of an infrared ray is high, the image processing module 414 increases the degree of transformation (e.g., the degree of improvement of an image). Contrarily, if the illuminance, the intensity of an ultraviolet ray or the intensity of an infrared ray is low, the image processing module 414 reduces the degree of transformation.

For example, if the image processing apparatus 400 is located outdoors (i.e., the place where the illuminance is high), the image processing module 414 may increase the degree of transformation, but if the image processing apparatus 400 is located indoors (i.e., the place where the illuminance is low), the image processing module 414 may reduce the degree of transformation.

For example, in an ill-lighted indoor environment, the illuminance and UV is about 0˜800 Lux and about zero, respectively. In this case, the image processing module 414 may determine that the degree of transformation of the image is low. In a case of the illuminance of about 4,000˜4,000 Lux corresponding to the cloudy afternoon, the image processing module 414 may determine that the degree of transformation is to be higher than the above example. In a case of the illuminance of about 40,000 Lux corresponding to the clear afternoon, the image processing module 414 may determine, for example, the maximum degree of transformation.

There might be a significant difference between the displayed image and the image that a user is viewing in the environment of a high illuminance or outdoor place. This is because a high illuminance may exert a noise on the displayed image that causes a reduction of the visibility when a user views the displayed image. Since the image processing apparatus 400 varies the degree of transformation by using at least one of the illuminance information, the ultraviolet information, the infrared information, or the indoor/outdoor information, the image processing apparatus 400 of the present invention can improve the visibility.

The image processing module 414 determines whether the image is to be transformed based on the status information of the image processing apparatus 400. For example, the image processing module 414 adjusts the degree of image transformation, considering the brightness of a display 440 of the image processing apparatus 400. For example, if the brightness of the display 440 is high, the image processing module 414 reduces the degree of transformation, and contrarily, if the brightness of the display 440 is low, the image processing module 414 increases the degree of transformation. Since the degree of image transformation varies with the brightness of the display 440, when the brightness of the display 440 is high due to a user's setup or the status of the image processing apparatus 400, the degree of image transformation is reduced, which can save on power consumption. Further, the visibility can be improved.

The image processing module 414 determines whether the image is to be transformed based on the user information. For example, the image processing module 414 determines whether the image is to be transformed based on the pupil information of a user or the pupil location information of a user. For example, if the user's pupil is big, which means a low illuminance, the image processing module 414 relatively reduces the degree of transformation. On the contrary, if the user's pupil is small, which means a high illuminance, the image processing module 414 relatively increases the degree of transformation. In addition, the image processing module 414 determines to take a display area where the user is viewing for an image transformation area by recognizing the user's pupil or the location of the pupil.

The image processing apparatus 400 implements a multi-window state wherein at least two images may be simultaneously displayed to a user. In this case, the image processing module 414 may transform one image, while it may not transform another image. For example, the image processing module 414 may transform an image that is determined to be an active window according to the user's pupil or the location of the pupil, while images of other windows may not be transformed.

The active window may be determined according to criteria, such as a window that has the latest interaction with a user, a window that is located in the area where a user is gazing for a predetermined time, and a window that requires a user's attention, like an alert window.

The image processing module 414 determines whether the transformed image corresponding to the given image has been pre-stored. Further, when the pre-stored transformed image corresponding to the given image exists, the image processing module 414 does not transform the image any more, but outputs the pre-stored transformed image. For example, a user may frequently see the same images which are stored in a gallery. In this case, the image processing module 414 stores the first transformed image of the given image, and then when the given image is input again, the image processing module 414 outputs the stored transformed image, preventing the repeated transformation of the image.

For example, the image processing module 414 stores the transformed image in a thumbnail form which is used for registering moving images or still images. When a user chooses the same image, the image processing module 414 may output the stored transformed image without transforming of the image which incurs power consumption. Accordingly, the image processing apparatus 400 according to an embodiment of the present invention can improve a power consumption and a load of a CPU/GPU resulting from the repeated transformation of the same image.

According to the present invention, the degree of transformation of the given image is determined based on the standstill state or the moving state of the image processing apparatus 400. According to an embodiment of the present invention, when the image processing apparatus 400 is determined to be in the standstill state, the image processing module 414 transforms the given image and outputs the image of improved visibility, and when the image processing apparatus 400 is determined to be in the moving state, the image processing module 414 does not transform the given image and output, for example, the original image, or perform an image transformation by a low degree (e.g., the degree lower than that of the case in which the image processing apparatus 400 is in the standstill state).

According to an embodiment of the present invention, when it is determined that, relatively, a user does not move actively (e.g., low or medium) or keeps motionless based on the body parts (e.g., a face or a pupil) of the user, the image improvement module 410 performs the transformation of the given image in order to improve the visibility of the image and output the transformed image to the user. Otherwise, when it is determined that, relatively, the user is in the state of active movement (e.g., high), the image improvement module 410 does not perform the transformation of the given image and output the image (e.g., the original image) that is originally input, or perform the transformation of the given image by a low degree (e.g., the degree lower than that of the case in which the user stays motionless or is walking).

According to an embodiment of the present invention, the image processing module 414 determines the transformation of the given image with consideration of the movements of both the image processing apparatus 400 and a user. In this case, the degree of transformation of the given image is determined based on a standstill state or a moving state of at least one of the image processing apparatus 400 and the user. Accordingly, the transformation of the image is selectively performed only when it is possible to improve visibility. Otherwise, the transformation of the image is not be performed or may be partially performed, which can save on power consumption resulting from the image process for the improvement of the visibility.

The image storage module 416 stores the transformed image generated from the image or the degree of transformation. The image obtaining module 418 obtains one or more images to be transformed or processed from the inside or the outside of the image processing apparatus 400. For example, according to an embodiment of the present invention, the image obtaining module 418 obtains an image to be displayed from the image storage module 416. According to an embodiment of the present invention, the image obtaining module 418 obtains the image from at least one of an electronic apparatus 480 (e.g., another image processing apparatus or a user apparatus) that is connected with the image processing apparatus 400 through a network 460 (e.g., the communication unit 230 shown in FIG. 2), such as the Internet, and a near filed wireless communication, a server 470 corresponding to the image processing apparatus 400, or a third party server 490 (e.g., service provider servers).

When the brightness of a display 440 is adjusted according to the image transformation of the image processing module 414, the display control module 419 controls the brightness of the display 440. According to an embodiment of the present invention, the display control module 419 is not configured in the image improvement module 410, but in a separate module.

The memory 420 (e.g., the internal memory 204A or the external memory 240B shown in FIG. 2) stores the transformed image or the degree of transformation. The sensor module 430 is configured with various sensors, and includes, for example, an illuminance sensor, a UV sensor, an infrared sensor, a gyro-sensor, or an object recognition sensor.

The display 440 outputs images to a user. The processor 450 (i.e., the processor 201 shown in FIG. 2) controls at least a part of the above-described modules. Also, the processor 450 determines whether the transformation of the given image is to be performed, for example, for the improvement of the visibility, based on at least one of the environment information, the image property information, the device status information, or the user information, and performs processing of the image as the result.

The image processing module 414 determines the transformation of the image based on the automatic transformation of the image that is set up by a user. Further, the image processing module 414 determines the degree of transformation of the given image based on the degree of transformation that is set up by a user. This is for reflecting a difference by which the degree of transformation of the image, that is automatically transformed (i.e., the image processing apparatus 400 automatically transforms the image based on the image processing information), might be high or low depending on the users. For example, the image processing module 414 varies the degree of image transformation based on the degree of transformation that is set up by a user, so that the difference of the visibility according to the users can be taken into account.

According to an embodiment of the present invention, the image processing module 414 adjusts (i.e., selects) the degree of transformation according to a user input. For example, in a case in which various relations (e.g., a mathematical relation) about the degree of image transformation with respect to the image processing information are expressed as profiles, a user may adjust the degree of transformation by selecting one profile from one or more provided profiles. Even though the degree of image transformation is automatically determined to be provided based on the image processing information, it is possible to additionally adjust the automatically determined degree of transformation by a user input in order to reflect the difference of the visibility from the user. For example, the relation degree (e.g., relation formula) about the degree of image transformation with respect to the image processing information may not be provided as a default, or although the relation degree is provided as a default, a user may adjust the default of the relation degree.

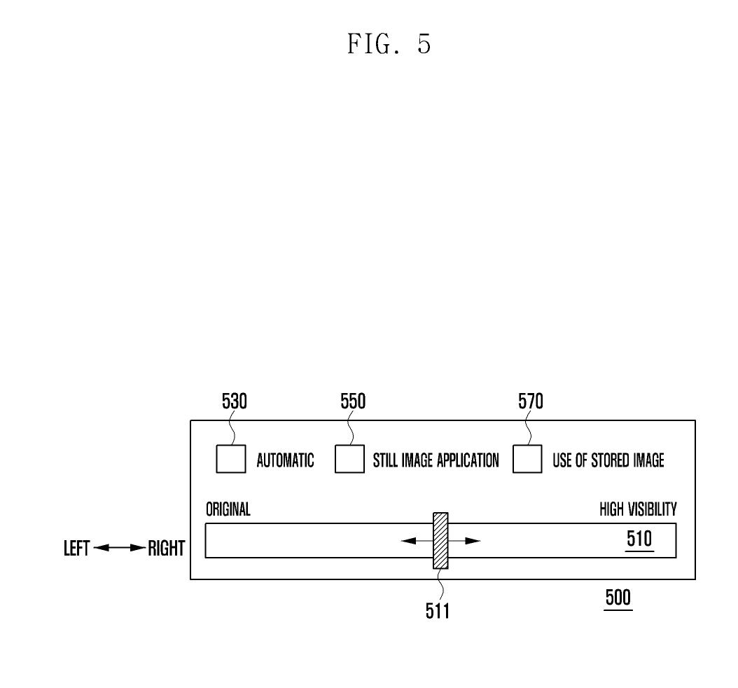

According to an embodiment of the present invention, the image processing module 414 provides an interface by which a user is able to select one of at least one piece of relation information with respect to the image processing information and the degree of image transformation by means of a user input. Additional description of the user interface will follow in FIG. 5 below.

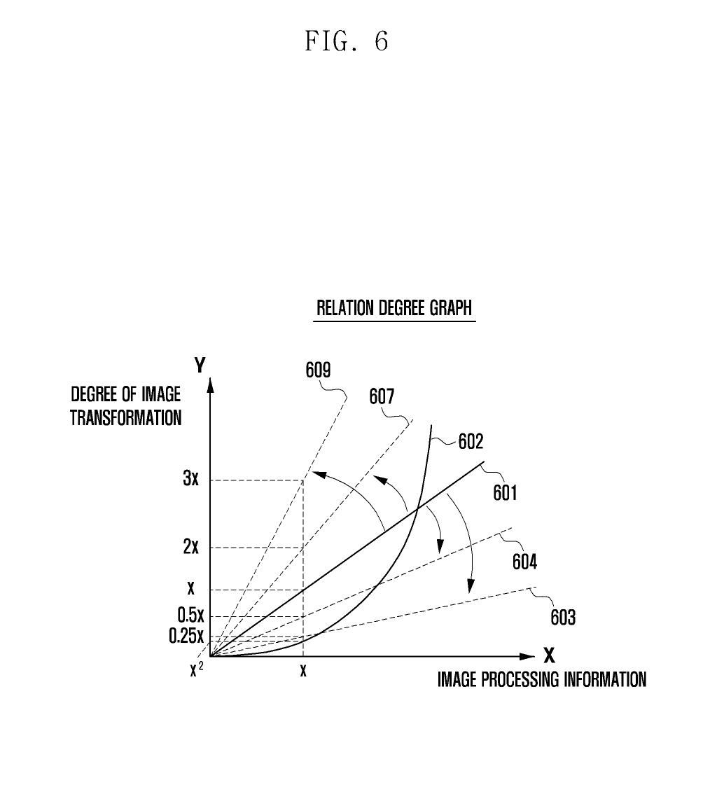

According to an embodiment of the present invention, the image storage module 416 stores at least one piece of relation information (e.g., a profile) about the degree of image transformation with respect to the image processing information, and the image processing module 414 uses at least one of the stored pieces of relation information (e.g., a profile) that is selected by a user using the user interface for the transformation of the image. Additional description of the relation information will follow in FIG. 6 below.

FIG. 5 illustrates a user interface 500 for the setting of an image transformation mode in an electronic apparatus (e.g., the image processing apparatus 400 shown in FIG. 4) according to an embodiment of the present invention. The user interface 500 includes a transformation degree setting area 510 to set up the degree of image transformation (i.e., the degree of improvement of visibility), an automation checkbox 530, a still image application checkbox 550, and a use of stored image checkbox 570. The transformation degree setting area 510 allows a user to directly set up the degree of image transformation. The transformation degree setting area 510 further includes a bar 511 (e.g., an indicator) that shows the current degree of transformation. For example, as the bar 511 moves to the left, the degree of transformation may have a small value, and then an image approximate to the original image may be output. On the contrary, as the bar 511 moves to the right, the degree of transformation may have a large value, and then the transformed image of high visibility may be output.

The automation checkbox 530 allows a user to set up the transformation of the given image based on, for example, the image processing information (when set to automatic mode) or the degree of transformation that is set up by the user (when set to non-automatic mode). For example, when a user selects the automation checkbox 530, the image processing apparatus 400 transforms the image by the degree of image transformation that is automatically set up (i.e., calculated) based on the image processing information. Otherwise, for example, when a user does not select the automation checkbox 530, the image processing apparatus 400 transforms the image by the degree of image transformation that is set up by the user. In this case, the image processing apparatus 400 adjusts the image processing information.

The still image application checkbox 550 allows a user to set up the transformation of the image by which a still image may be transformed, while a moving image may not be transformed. For example, according to an embodiment of the present invention, when a user selects the still image application checkbox 550, the image processing apparatus 400 transforms the still image only, but does not transform the moving image.

The use of stored image checkbox 570 allows a user to determine whether the transformed image has been pre-stored or not. For example, the use of stored image checkbox 570 is selected, the image processing apparatus 400 determines whether the image transformed from the given image has been pre-stored. Further, when the stored transformed image exists, the image processing apparatus 400 outputs the stored transformed image. Otherwise, the image processing apparatus 400 performs the transformation of the image. On the contrary, when the stored image using checkbox 570 is not selected, the image processing apparatus 400 does not determine whether the image transformed from the image has been pre-stored, and directly perform the transformation of the image.

According to an embodiment of the present invention, the user interface 500 is provided by the image processing module 414. According to an embodiment of the present invention, a part or all of the functions of the image processing module 414, including the user interface 500, may be provided by other modules (e.g., the image storage module 416 or the image improvement server module 470).

FIG. 6 is a graph 600 illustrating a relation of the degree of image transformation with respect to the image processing information according to various embodiments of the present invention. The X-axis of the graph 600 denotes the image processing information (e.g., the environment information, the device status information, the image property information, and the user information), and the Y-axis of the graph denotes the degree (i.e., a percentage (%)) of image transformation. Each relation degree (e.g., a profile) may be expressed as a mathematical (e.g., discrete, linear, or exponential) formula corresponding to the variation of the degree of image transformation with the increase and the decrease in the value of the image processing information.

According to various embodiments of the present invention, as shown in FIG. 6, when the X denotes at least one value of the image processing information, and the Y denotes a value of the degree of the corresponding image transformation, the relation information may be expressed as y=0.25x (as in graph 603), y=0.5x (as in graph 604), y=x (as in graph 601), y=2x (as in graph 607), y=3x (as in graph 609), or y=x2 (as in graph 602). Additionally or alternatively, the relation information (e.g., a profile) may be configured with a text (e.g., “high”, “medium” or “low”), a corresponding image corresponding, or the combination thereof. Further, additionally or alternatively, the relation information may be a free-form curve showing the degree of image transformation having an optimum value with respect to the image processing information.

According to various embodiments of the present invention, at least one relation information (e.g., a profile) is stored in the image processing apparatus 400 (e.g., the image storage module 416 or the memory 430), and is provided by a user interface 500 to a user to select at least one of them. For example, when the bar 511 (indicating the current degree of transformation) of the user interface 500, shown in FIG. 5, stays around the middle of the transformation degree setting area 510, the relation information corresponding to graph 601 may be selected. Likewise, as the bar 511 moves to the left in the transformation degree setting area 510, the degree of transformation corresponding to graph 604 or graph 603 may be selected, and contrarily, as the bar 511 moves to the right in the transformation degree setting area 510, the relation information corresponding to graph 607, graph 609 or graph 602 may be selected. According to an embodiment of the present invention, when the automatic transformation of the image is selected, the relation information of the graph 601 (e.g., y=x) is provided as a default of the degree of image transformation profile.

In the selecting the degree of image transformation by a user, the use of this relation information enables a user to adjust the degree of image transformation of the corresponding image to his desire, according to the change of the value of the corresponding image processing information (e.g., the illuminance, shaking, or the type of image (still images or moving images)), instead of making the degree of transformation to be fixed to one value (e.g., 20%, 30%, 40% or 50%). This can provide an adaptive image transformation method and apparatus by which the degree of image transformation varies with the change of the environment information, the device information, the image property information, or the user information, and the difference of visibility of a user can be reflected as well.

An electronic apparatus or method, according to various embodiments of the present invention, determines whether a visibility improvement algorithm needs to be applied, or the degree of image transformation according to, for example, the intensity of the illuminance, the brightness of a display, the degree of image transformation set up by a user, the user information, or the status information of the electronic apparatus. Accordingly, when the visibility improvement has no effect or low effect, for example, the transformation of the given image may not be processed or may be processed by a low degree, which can improve the visibility of the image displayed in the electronic apparatus, and save a power consumption as well.

The embodiment of the present invention, together with the modules, may be implemented in a non-transitory computer-readable, or equivalent device-readable, recording medium by using software, hardware, or the combination thereof. In terms of hardware, the embodiment of the present invention may be implemented by using at least one of application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, or electric units for performing of other functions. For example, each of the modules may be implemented in the processor 450 to thereby perform the above-described steps. In addition, a part or all of the modules may be integrated in a single module, but the module may, nevertheless, perform the same functions as those before integration.

Although, for the convenience of explanation, each of the modules (e.g., the image improvement module 410), according to the embodiment of the present invention, is operated in a user device (e.g., a client), like the image processing apparatus 400, according to another embodiment of the present invention, at least some modules may be implemented to operate in a server 470 that is functionally connected with the image processing apparatus 400. For example, as shown in FIG. 4, the server 470 may include an image improvement server module 471 that can perform functions of some modules (e.g., the image information module 412, the image processing module 414, the image storage module 416, or the image obtaining module 418) of the image improvement module 410.

In addition, according to an embodiment of the present invention, the functions are performed using either the image processing apparatus 400 or the server 470, or both.

According to various embodiments of the present invention, an electronic apparatus includes an obtaining module for obtaining at least one image, an information module for determining at least one of property information of the at least one image, status information of the electronic apparatus, environment information related to the electronic apparatus, or user information, and a processing module for determining whether the at least one image is to be transformed based on the at least one piece of information.

According to various embodiments of the present invention, the processing module transforms the at least one image to be thereby output when the electronic apparatus stays motionless, and when the electronic apparatus is in a moving state, the processing module may display the at least one image without transformation.

According to various embodiments of the present invention, the processing module is set up to determine the degree of transformation of at least one image based on a standstill state or a moving state of at least one of the electronic apparatus or a user of the electronic apparatus.

According to various embodiments of the present invention, the at least one image include a first image and a second image, and the processing module is set up to transform the first image based on a first degree of transformation and the second image based on a second degree of transformation.

According to various embodiments of the present invention, the processing module is set up to select at least one from the at least one piece of information and the at least one relation information with respect to the degree of transformation, based on a user input.

According to various embodiments of the present invention, the processing module is set up to provide a user interface that allows a user to set up a transformation mode or the degree of transformation with respect to the at least one image.

According to various embodiments of the present invention, the electronic apparatus further includes a memory that stores the transformed image of the at least one image or the degree of transformation.

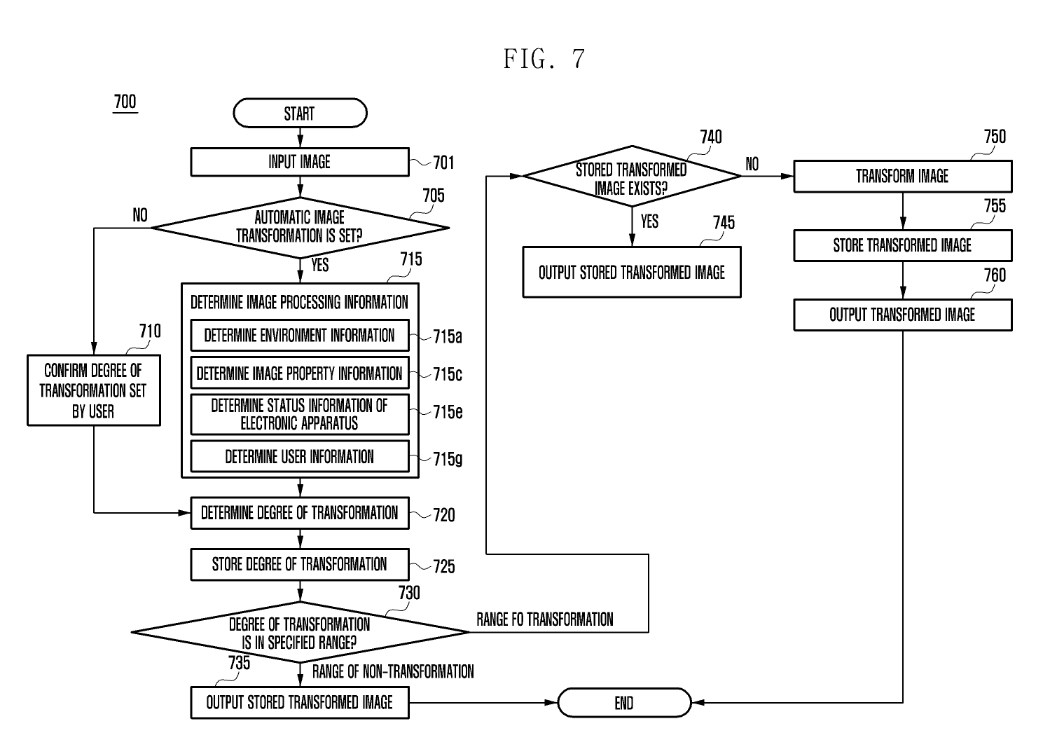

FIG. 7 illustrates a method 700 of processing an image using an electronic apparatus (e.g., the image processing apparatus 400 shown in FIG. 4), according to various embodiments of the present invention. In step 701, the image obtaining module 418 obtains an image (i.e., the original image) to be processed. In step 705, the image processing module of the image processing module 414 determines whether the image to be processed is to be transformed based on image processing information (i.e. when the image transformation mode is set to the automatic mode), or by considering the degree of transformation that is set up by a user (i.e. when the image transformation mode is set to the non-automatic mode). According to an embodiment of the present invention, a user may directly set up the automatic image transformation by a user interface.

When the image transformation is determined to be performed by the degree of transformation set up by a user (i.e., non-automatic image transformation mode), the image processing module 414 confirms the degree of transformation set up by a user in step 710. In step 720, the image processing module 414 determines the degree of image transformation based on the degree of transformation set up by the user.

When the image transformation mode is set up to be the automatic transformation (e.g., when the image processing module 414 is to transform the image based on the image processing information), the image information module 412 determines the image processing information in step 715.

According to an embodiment of the present invention, in determining the image processing information, in step 715a, the environment information module 412a determines environment information related to the image processing apparatus 400. The image property information module 412c determines property information of the obtained image (i.e., the image to be processed) in step 715c.

In step 715e, the device status information module 412e determines status information (e.g., standstill or moving information, the brightness of the display 440 (e.g., the display unit 209 shown in FIG. 2), or the degree of transformation set up by a user) of the image processing apparatus 400. In step 715g, the user information module 412g determines visual characteristic information (e.g., pupil information) or standstill/moving information (e.g., based on the pattern of the movement of a face or eyes) of a user of the image processing apparatus 400.

In step 720, the image processing module 414 determines the degree of transformation based on the image processing information. In step 725, the image storage module 416 stores the degree of transformation. In step 730, the image processing module 414 determines if the degree of transformation is in the specified range of transformation. For example, the image processing module 414 determines in step 730, whether the degree of transformation is in a range that requires the transformation of the image or not.

When the degree of transformation is not in the range that requires the transformation of the image, the image processing module 414 outputs the image (e.g., the original image) in step 735.

When the degree of transformation is in the range that requires the transformation of the image, the image processing module 414 determines in step 740, whether a transformed image corresponding to the image (e.g., the original image) has been pre-stored. For example, in step 740, the image processing module 414 determines whether the transformed image (e.g., the image of improved visibility) corresponding to the image exists or not.

When the stored transformed image corresponding to the image exists, the image processing module 414 outputs the pre-stored transformed image in step 745. For example, the image processing module 414 outputs the pre-stored transformed image.

When the pre-stored transformed image corresponding to the image does not exist, the image processing module 414 transforms the image based on the transformation information in step 750. For example, in a case of a high illuminance (e.g., when outdoors) in which the degree of transformation is determined to be high, the image processing module 414 transforms the image at a high degree of transformation. On the contrary, in a case of a low illuminance (e.g., when indoors) in which the degree of transformation is determined to be low, the image is transformed at a low degree of transformation.

In addition, in step 750, the image processing module 414 varies the degree of image transformation with the brightness of the display 440. For example, the image processing module 414, when the brightness of the display 440 is high, reduces the degree of transformation (i.e., the degree of improvement), and when the brightness the display 440 is low, increases the degree of transformation (i.e., the degree of improvement).

In addition, in step 750, the image processing module 414 varies the degree of transformation based on the degree of transformation set up by a user. When the image is set up to be transformed based on only the degree of transformation set up by a user (when the image transformation mode is set to the non-automatic mode), the image processing apparatus 414 transforms the image according to the degree of transformation set up by a user, disregarding the image processing information. Further, in step 750, the image processing module 414 varies the degree of transformation based on user's visual information.

In addition, in step 750, the image processing module 414 enhances the visibility of the image to be output to a user based on the image processing information.

In step 755, the image storage module 416 store the transformed image. The transformed image is an image in which visibility is higher than that of the original image. In addition, the display 440 outputs the transformed image in step 760.

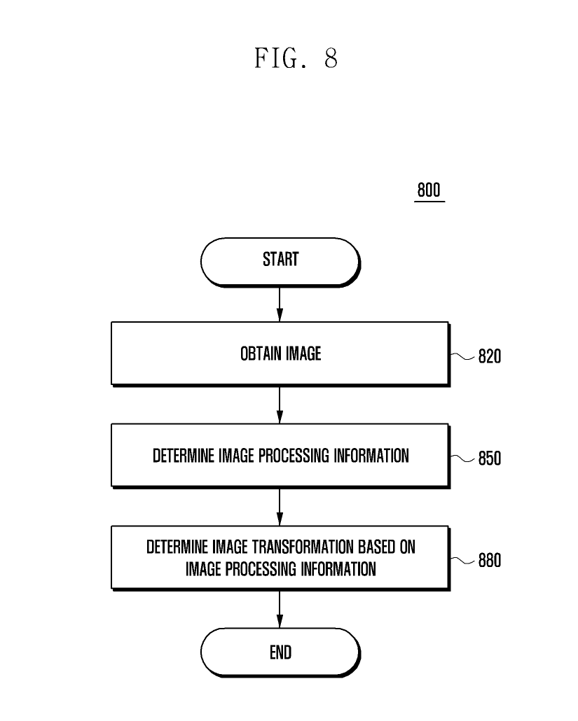

FIG. 8 is a flowchart 800 illustrating a method of transforming an image using an electronic apparatus (e.g., the image processing module 400 shown in FIG. 4), according to various embodiments of the present invention.

In step 820, the image obtaining module 418 obtains an image to be processed from an internal or external source. In step 850, the image information module 412 determines (i.e., recognizes) at least one of property information of the obtained image, status information of the electronic apparatus, environment information related to the electronic apparatus, or user information of the electronic apparatus. In step 880, the image processing module 414 determines whether the obtained image is to be transformed based on the image processing information. The image processing module 414 determines whether to perform the transformation of the obtained image, or whether to perform transformation of a part of the image, according to the determination of the image processing information.

According to various embodiments of the present invention, a method of transforming an image using an electronic apparatus includes obtaining at least one image, determining at least one piece of information from among the property information of the at least one image, status information of the electronic apparatus, environment information related to the electronic apparatus, or user information, and determining whether the at least one of image is to be transformed based on the at least one piece of information.

According to various embodiments of the present invention, determining whether the at least one image is to be transformed includes, when the at least one piece of information is in a specified range, transforming the at least one image and outputting the transformed image, and when the at least one piece of information is not in a specified range, outputting the at least one image.

According to various embodiments of the present invention, determining whether the at least one image is to be transformed includes determining the degree of transformation for transforming the at least one image.

According to various embodiments of the present invention, determining whether the at least one image is to be transformed includes automatically generating the degree of transformation based on the at least one piece of information, or receiving the degree of transformation by a user input.

According to various embodiments of the present invention, determining the degree of transformation includes determining the degree of transformation using brightness information of a display of the electronic apparatus or the degree of transformation set up by a user.

According to various embodiments of the present invention, determining whether the at least one image is to be transformed includes, when a transformed image corresponding to the at least one image has been pre-stored, outputting the transformed image.

According to various embodiments of the present invention, determining whether the at least one image is to be transformed includes, when the at least one image is a still image, transforming the at least one image, and when the at least one image is a moving image, not transforming the at least one image.

According to various embodiments of the present invention, determining whether the at least one image is to be transformed includes varying the degree of transformation with at least one of an illuminance, the intensity of an ultraviolet ray, or the intensity of an infrared ray of the environment information.

According to various embodiments of the present invention, determining whether the at least one image is to be transformed includes when the at least one image is determined to be a moving image, transforming at least one frame of a multitude of frames constituting the moving image.

According to various embodiments of the present invention, determining whether the at least one image is to be transformed includes varying the degree of transformation with visual information of the user information.

According to various embodiments of the present invention, the at least one image includes a first image and a second image, and the determining whether the at least one image is to be transformed may include transforming the first image and not transforming the second image.

According to various embodiments of the present invention, the brightness of the display of the electronic apparatus is adjusted based on the result of determination of transformation of image.

According to various embodiments of the present invention, each of the operations may be performed subsequently, repeatedly, or concurrently. Further, some operations may be omitted, or other operations may be added. In addition, for example, as described above, each of the operations may be performed by new modules which correspond to the modules described in the above embodiments or a combination thereof.

Various embodiments of the present invention may be implemented in the form of program instructions which can be performed by various computing devices (e.g., the processor 450) to be thereby recorded in a non-transitory computer-readable recording medium. The computer-readable recording medium may include program instructions, data files, and data structures alone or a combination thereof. The program instructions recorded in the recording medium may be specially designed and configured for the embodiment of the present invention, or be something well-known to those skilled in the field of computer software for usage.

The computer-readable recording medium includes magnetic media such as hard disks, floppy disks and magnetic tapes, optical media such as a Compact Disc Read-Only Memory (CD-ROM) and a Digital Versatile Disc (DVD), magneto-optical media such as floptical disks, and hardware devices such as a Read-Only Memory (ROM), a Random Access Memory (RAM) and a flash memory, which are specially configured to store and perform program instructions. Further, the program instruction includes a machine language code generated by a compiler and a high-level language code executable by a computer through an interpreter and the like. The hardware devices may be configured to operate as one or more software modules to perform the steps of the present invention, and vice versa.

The description of embodiments and the drawings, provided herein, are just examples for facilitation of explanation and understanding of the present invention, and the scope of the present invention is not limited thereto. Accordingly, it should be understood that apart from the embodiments described in the description, various modifications and transformations based on the technical concept of the present invention may be included in the scope of the present invention, as defined by the appended claims and their equivalents.

What is claimed is:

1. A method of processing an image using an electronic apparatus, the method comprising
obtaining at least one image;
determining at least one piece of information from among property information of the at least one image, status information of the electronic apparatus, environment information related to the electronic apparatus, or user information; and
determining whether the at least one image is to be transformed based on the at least one piece of information.

2. The method of claim 1, wherein determining whether the at least one image is to be transformed comprises:
when the at least one piece of information is in a specified range, transforming the at least one image and outputting the transformed image; and
when the at least one piece of information is not in a specified range, outputting the at least one image.

3. The method of claim 1, wherein determining whether the at least one image is to be transformed comprises determining whether the at least one image is to be transformed according to a degree of transformation.

4. The method of claim 3, wherein determining whether the at least one image is to be transformed comprises automatically generating the degree of transformation based on the at least one piece of information, or receiving the degree of transformation by a user input.

5. The method of claim 3, wherein determining the degree of transformation comprises determining the degree of transformation using brightness information of a display of the electronic apparatus.

6. The method of claim 3, wherein determining the degree of transformation comprises determining a degree of transformation set by a user.

7. The method of claim 1, wherein determining whether the at least one image is to be transformed comprises, when a transformed image corresponding to the at least one image has been pre-stored, outputting the pre-stored transformed image.

8. The method of claim 1, wherein determining whether the at least one image is to be transformed comprises:
determining, using the property information of the at least one image, whether the at least one image is a moving image or a still image;
when the at least one image is a moving image, not transforming the at least one image; and
when the at least one image is a still image, transforming the at least one image.

9. The method of claim 3, wherein determining whether the at least one image is to be transformed comprises varying the degree of transformation with at least one of an illuminance, an intensity of an ultraviolet ray, or an intensity of an infrared ray from the environment information.

10. The method of claim 1, wherein determining whether the at least one image is to be transformed comprises:
determining a state of a user of the electronic apparatus using the user information, wherein the state is a standstill state or a moving state;
when the user is in the standstill state, transforming the at least one image and outputting the transformed image; and
when the user is in the moving state, outputting the at least one image.

11. The method of claim 3, wherein determining whether the at least one image is to be transformed comprises varying the degree of transformation with visual information of the user information.

12. The method of claim 1, wherein the at least one image comprises a first image and a second image, and
determining whether the at least one image is to be transformed comprises transforming the first image and not transforming the second image.

13. The method of claim 1, wherein determining whether the at least one image is to be transformed includes adjusting brightness of a display of the electronic apparatus according to a result of the determining whether the at least one image is to be transformed.

14. An electronic apparatus comprising:
an obtaining module configured to obtain at least one image;
an information module configured to determine at least one piece of information from among property information of the at least one image, status information of the electronic apparatus, environment information related to the electronic apparatus, or user information; and
a processing module configured to determine whether the at least one image is to be transformed based on the at least one piece of information.

15. The apparatus of claim 14, wherein the processing module is set up to determine the state of the electronic apparatus using the status information of the electronic apparatus, and when the electronic apparatus is in a standstill state, to transform the at least one image and to output the transformed image, and when the electronic apparatus is in a moving state, to output the at least one image.

16. The apparatus of claim 14, wherein the processing module is set up to determine the state of the electronic apparatus using the status information of the electronic apparatus, to determine the state of a user of the electronic apparatus using the user information, and to determine a degree of transformation based on the state of at least one of the electronic apparatus or the user of the electronic apparatus, wherein the state is a standstill state or a moving state.

17. The apparatus of claim 14, wherein the at least one image comprises a first image and a second image, and the processing module is set up to transform the first image based on a first transformation degree, and to transform the second image based on a second transformation degree.

18. The apparatus of claim 16, wherein the processing module is set up to select one of at least one relation information with respect to the at least one piece of information and the degree of transformation, based on a user input.

19. The apparatus of claim 14, wherein the processing module provides a user interface that allows a user to set up a transformation mode or a degree of transformation of the at least one image.

20. The apparatus of claim 16, further comprising a memory that stores the transformed image or the degree of transformation of the at least one image.

21. A non-transitory computer readable recording medium having recorded thereon, a computer program for executing a method of processing an image using an electronic apparatus, the method comprising:
obtaining at least one image;
determining at least one piece of information from among property information of the at least one image, status information of the electronic apparatus, environment information related to the electronic apparatus, or user information; and
determining whether the at least one image is to be transformed based on the at least one piece of information.
